(19) United States
(12) Patent Application Publication
(10) Pub. No.: US 2012/0201013 A1
(43) Pub. Date: Aug. 9, 2012

(54) Safety Goggles With Self-Enclosed Illumination Tracks

(76) Inventor: Jared Rementer, Bound Brook, NJ (US)

(21) Appl. No.: 13/022,424

(22) Filed: Feb. 7, 2011

(51) Int. Cl. F21V 21/08

(52) U.S. Cl. 362/103

(57) ABSTRACT

A safety goggle for use in a dimly lit or dark environment comprising: a protective lens; a lens holder, where the lens holder provides a means to contain and support the protective lens; a first series of LED track lighting on one side of the lens holder outside of the protective lens; a second series of LED track lighting on an opposite side of the lens holder outside of the protective lens; a third series of LED track lighting on a top side of the lens holder outside of the protective lens; and a means to power the LED tracking surrounding the protective lens. The means to power the LED tracking may include batteries within the lens holder and a power button may be provided to turn the LED track lighting on.

### BACKGROUND OF THE INVENTION

1. Field of Invention

The present invention relates to safety goggles that include illuminated LED light tracks around the outer rim of the goggle.

2. Description of Related Art

Safety goggles or glasses provide protective eyewear for the user to prevent particles, water or chemicals from entering or striking the user's eyes. Safety goggles are used in various occupations and are required in certain construction applications. Goggles are also used for sporting activities such as snow skiing and swimming. Use of goggles helps to prevent damage or injury to the eyes due to exposure to foreign objects, hazardous chemicals or in some cases simply water.

In instances where safety goggles are used in dark spaces or dark environments a user must also utilize a flashlight to see the objects or to perform their tasks. Consequently, it would be advantageous to have goggles that include a light source directly on the goggles for use in a dark environment. Examples of illuminated safety glasses have been disclosed in U.S. Pat. No. 6,824,265 which discloses an illuminated safety glasses that utilizes light emitting diodes embedded onto a one-piece flexible array mounted on the left and right side of the glass lenses. Yet another example of illuminated goggles is disclosed in U.S. Patent No. 2001/0021108 that discloses a gazing point illuminating device that provides a light source that includes a directional changing mechanism for changing the light direction of the light source, also with a gazing direction detector to detect the direction of the user's gazing line.

Although the prior art provides some guidance in the area of lighted goggles further development of similar devices is needed, in particular so a more compact assembly of the LED lights on the safety goggles is needed.

### SUMMARY OF THE INVENTION

The present invention relates to a safety goggle for use in a dimly lit or dark environment comprising: a protective lens; a lens holder, where the lens holder provides a means to contain and support the protective lens; a first series of LED track lighting on one side of the lens holder outside of the protective lens; a second series of LED track lighting on an opposite side of the lens holder outside of the protective lens; a third series of LED track lighting on a top side of the lens holder outside of the protective lens; and a means to power the LED tracking surrounding the protective lens. The means to power the LED tracking may include batteries within the lens holder and a power button may be provided to turn the LED track lighting on.

### BRIEF DESCRIPTION OF DRAWINGS

FIG. 1 depicts LED illuminated safety goggles according to the present invention.

### DETAILED DESCRIPTION

The present invention relates to a safety goggle that includes a plurality of LED lighting tracks on the parameter of the lens of the safety glasses. A series of LED lights are lighted on each side of the lens of the safety goggles according to the present invention along with a plurality of lights along the top of the lens according to the present invention. The LED lights provide a surrounding emission of light sources that is powered by rechargeable batteries contained within the goggles. The positioning of the light sources around the lens of the safety goggles provide an effective means to provide a light source for the user of the safety goggles.

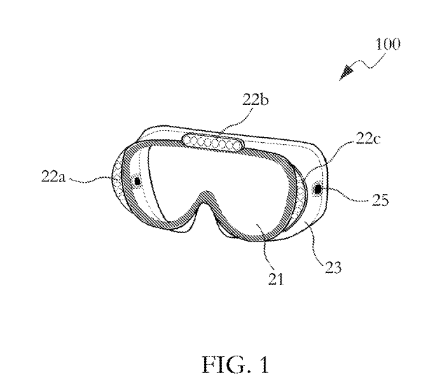

In reference to FIG. 1, a pair of LED equipped safety goggles 100 is depicted. The LED equipped safety goggles 100 include a lens 21 and three series of LED lighting tracks along the sides and parameter of the lens 21. A first LED track 22a is provided on one side, a second LED track 22b is divided at the top of the lens and a third LED track 22c is provided on the opposing side of the lens 21. The lens 21 is contained within a lens holder 23. The lens holder 23 provides a base for supporting lens 21 and the LED tracks 22a, 22b, 22c. The holder 23 combined with the lens 21 comprises the basis of the goggle 100 according to the present invention. A power button 25 is provided on one side of the goggle 100 to power or activate the LED tracking provided around the lens 21. This power source also provides the means to control the brightness of the light source provided by LED tracking

The safety goggles according to the present invention therefore create a suitable means for a light source connected directly to the safety protective eyewear of the goggles 100. Use of the goggles according to the present invention help to eliminate the necessity for a flashlight to see in a dimly lit or dark environment. The goggles also allow the user to have free use of their hands without having to secure direct lighting with a flashlight. The goggles may be worn with straps attached to the goggles and also could include replacement lenses in various colors as needed.

What is claimed is:

1. A safety goggle for use in a dimly lit or dark environment comprising:
a. a protective lens;
b. a lens holder, where the lens holder provides a means to contain and support the protective lens;
c. a first series of LED track lighting on one side of the lens holder outside of the protective lens;
d. a second series of LED track lighting on an opposite side of the lens holder outside of the protective lens;
e. a third series of LED track lighting on a top side of the lens holder outside of the protective lens; and
f. a means to power the LED tracking surrounding the protective lens.

2. The safety goggle according to claim 1, where the means to power includes batteries within the lens holder.

3. The safety goggle according to claim 2, further including a power button.
